(19) United States
(12) Patent Application Publication
(10) Pub. No.: US 2013/0126106 A1
(43) Pub. Date: May 23, 2013

(54) PNEUMATIC DOOR SEAL SYSTEMS AND METHODS

(71) Applicant: Donald James Hindman, San Diego, CA (US)

(72) Inventor: Donald James Hindman, San Diego, CA (US)

(73) Assignee: Hyundai Translead, San Diego, CA (US)

(21) Appl. No.: 13/587,566

(22) Filed: Aug. 16, 2012

Related U.S. Application Data
(60) Provisional application No. 61/562,292, filed on Nov. 21, 2011.

(51) Int. Cl. B60J 10/08; E06B 7/22; E06B 3/44

(52) U.S. Cl. 160/238; 160/405

(57) ABSTRACT

A door sealing system comprises a roll-up door assembly including at least one door panel and a pneumatic seal apparatus including an elastic membrane defining a channel therethrough and a base member fixedly attached to the elastic membrane via a neck portion. The elastic membrane is expandable by injection of pressurized air such that an expanded membrane applies outward force against the door panel to seal the roll-up door assembly.

### CROSS-REFERENCE TO RELATED APPLICATIONS

This application claims priority to U.S. Provisional Patent Application Ser. No. 61/562,292, filed Nov. 21, 2011, the disclosure of which is hereby incorporated by reference in its entirety.

### FIELD

The present disclosure relates to pneumatic door seal systems, apparatus and methods.

### BACKGROUND

Within the last few years the conservation of energy and corresponding reduction in air pollution as a result of heavy duty diesel powered trucks and refrigerated trailers has been a major topic. Many jurisdictions currently require reductions in energy use and air pollution by trucks and trailers relating to tractor idling as well as operation of diesel powered refrigeration units when being loaded, unloaded, or in standby mode at warehouses, loading docks, stores, and other general parking areas.

One important area for efficiency gains is the sealing capability of roll-up type doors on refrigerated trailers. By nature of construction, these devices need to have a space or clearance between segments of the door, i.e., door panels, and have relatively low resistance at the perimeter for them to operate properly. These roll-up type doors are less efficient from a BTU retention standpoint than swing-type doors. Additionally, forces created by the refrigeration unit push air against the door as it is used as a “bulkhead” to stop air and can create cause separate between the panels. Externally, a low pressure condition is created when the trailer is running down the road directly behind the trailer and in front of the door assisting in creating air loss at the joints of the door.

In current roll-up doors, the perimeter only has a passive seal, which can easily be displaced by the pressure exerted by the air flow from the refrigeration unit. Thus, there is a need for seal apparatus that can actively and effectively seal roll-up doors. There is a further need for seal apparatus and methods to effectively seal roll-up door assemblies on trailers. There also remains a need for a seal apparatus that can actively and effectively seal roll-up doors and can be integrated and used with trailers, particularly refrigerated trailers.

### SUMMARY

The present disclosure, in its many embodiments, alleviates to a great extent the disadvantages of known door seals by providing an elastic membrane that expands when pressurized air is introduced into it for the purposes of creating a seal and/or applying pressure preventing movement of the door panels. The design is such that the deployment of the seal aids in keeping the panels from separating. Thus, in the case of a refrigerated trailer, embodiments improve thermal capacity, and in the case of a dry van, improve the door's ability to prevent water ingress at all joints. The seal may be deployed by a manual or electrically-manipulated valve. Further it can also be automatically deployed using the supply line available on trailers equipped with air brakes. The membrane could be deployed on equipment without supply air available by providing a separate air supply source not intended for braking purposes.

In exemplary embodiments, a door sealing system comprises a roll-up door assembly and a pneumatic seal apparatus. The roll-up door assembly includes at least one door panel. The at least one door panel may comprise a plurality of door panels. The pneumatic seal apparatus is located adjacent the at least one door panel and includes an elastic membrane defining a channel therethrough and a base member fixedly attached to the elastic membrane via a neck portion. The pneumatic seal apparatus may comprise a header seal, a pneumatic gasket, and a door post seal, which may be integrally formed or three separate portions. The elastic membrane, the base member, and the neck portion may be integrally formed. The elastic membrane may be made of one or more of: fluoroelastomer, polyether urethane, styrene butadiene, epichlorohydrin, EPDM, silicone, butyl, nitrile, neoprene, or natural rubber.

The elastic membrane is expandable by injection of pressurized air such that an expanded membrane applies outward force against the door panel to seal the roll-up door assembly. The system may further comprise a valve to regulate the flow of pressurized air into the channel. In exemplary embodiments, the pressurized air is supplied from a trailer supply line. The trailer supply line may be fluidly connected to a brake release. The pressurized air may be supplied from a trailer air reservoir via a regulator, and the air may be pressurized by a refrigeration unit.

Exemplary embodiments include a sealing system for a trailer door, comprising a trailer and a pneumatic seal apparatus. The trailer has an air supply line and a roll-up door assembly, and the roll-up door assembly includes at least one door panel. The door panel may comprise a plurality of door panels. The trailer supply line may be fluidly connected to a brake release. The sealing system may further comprise a refrigeration unit fluidly connected to the trailer supply line wherein the air is pressurized by the refrigeration unit. The pneumatic seal apparatus is located adjacent the at least one door panel and includes an elastic membrane defining a channel therethrough and a base member fixedly attached to the elastic membrane via a neck portion. The pneumatic seal apparatus may comprise a header seal, a pneumatic gasket, and a door post seal, which may be integrally formed or three separate portions. The elastic membrane, the base member, and the neck portion may integrally formed. The elastic membrane is expandable by injection of air pressurized by the refrigeration unit, the air traveling to the channel via the air supply line such that an expanded membrane applies outward force against the door panel to seal the roll-up door assembly. The pressurized air may be supplied from a trailer air reservoir via a regulator.

Exemplary embodiments include methods of sealing a trailer door comprising injecting pressurized air into a pneumatic seal apparatus. The pneumatic seal apparatus is located adjacent the at least one door panel and has an elastic membrane defining a channel therethrough such that an expanded membrane applies outward force against a door panel to seal a roll-up door assembly. The methods may further comprise pressurizing the air using a refrigeration unit. Exemplary methods further comprise supplying the air from a trailer air reservoir via a regulator. The methods may further comprise supply the air via a trailer supply line, and the trailer supply line may be fluidly connected to a brake release. The methods may further comprise regulating flow of pressurized air into the channel using a valve.

Accordingly, it is seen that pneumatic sealing systems, apparatus and methods are provided that improve the sealing and thermal efficiencies of roll up doors, provide added security and reduce damage associated with vibration from traveling over the road. These and other features and advantages will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a perspective view of an embodiment of a trailer in accordance with the present disclosure;

FIG. 2 is a perspective view of an embodiment of a sealing system in accordance with the present disclosure;

FIG. 3 is a perspective view of an embodiment of a sealing system in accordance with the present disclosure;

FIG. 4 is a perspective view of an embodiment of a seal track in accordance with the present disclosure;

FIG. 5A is a perspective view of an embodiment of a pneumatic seal apparatus in accordance with the present disclosure;

FIG. 5B is a cross-sectional view of the pneumatic seal apparatus of FIG. 5A;

FIG. 6 is a schematic view of an embodiment of a sealing system in accordance with the present disclosure;

FIG. 7 is a schematic view of an embodiment of a sealing system in accordance with the present disclosure;

FIG. 8 is a cross-sectional view of an embodiment of a sealing system in accordance with the present disclosure;

FIG. 9A is a cross-sectional view of an embodiment of a sealing system in accordance with the present disclosure; and

FIG. 9B is a cross-sectional view of an embodiment of a sealing system in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects.

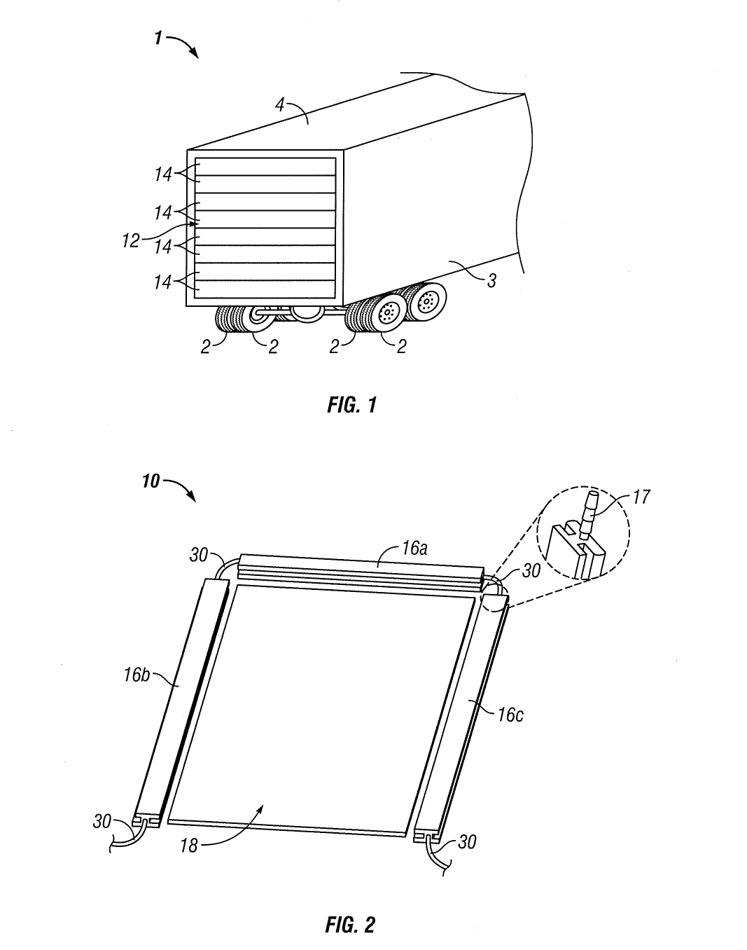

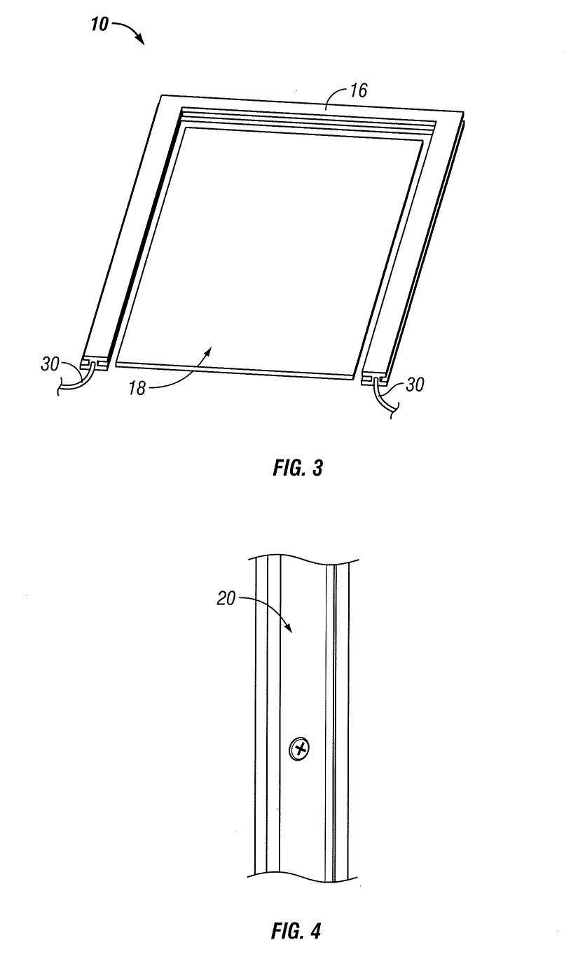

Referring to FIGS. 1-4, a trailer 1, commonly referred to as a semi-trailer or van, has wheels 2, side walls 3, a roof 4, and a roll-up door assembly 12 that includes at least one door panel 14. The roll-up door assembly 12 typically has space or clearance between the panels 14, or segments, of the door assembly. Inside views of the trailer 1, as in FIGS. 2 and 3, illustrate pneumatic seal apparatus 16. Pneumatic seal apparatus 16 is arranged around the perimeter of trailer doorway 18 so as to be adjacent to at least one of the door panels 14 and, in exemplary embodiments, adjacent the full roll-up door assembly 12. More particularly, pneumatic seal apparatus 16 is disposed in seal track 20, which extends around the perimeter of trailer doorway 18 and is sized to receive the seal apparatus 16.

The pneumatic seal apparatus 16 can be configured as a three-piece design, as shown in FIG. 2, or as a single-piece design joined together at the corners, as shown in FIG. 3. An embodiment of a three-piece design of pneumatic seal apparatus 16 comprises header seal 16a and door post seals 16b, 16c. A pneumatic gasket 17 may also be provided to fill any irregularities between the seals 16a, 16b, 16c and the roll-up door assembly 12. As described in more detail herein, trailer supply line 30 may supply air to the pneumatic seal apparatus 16.

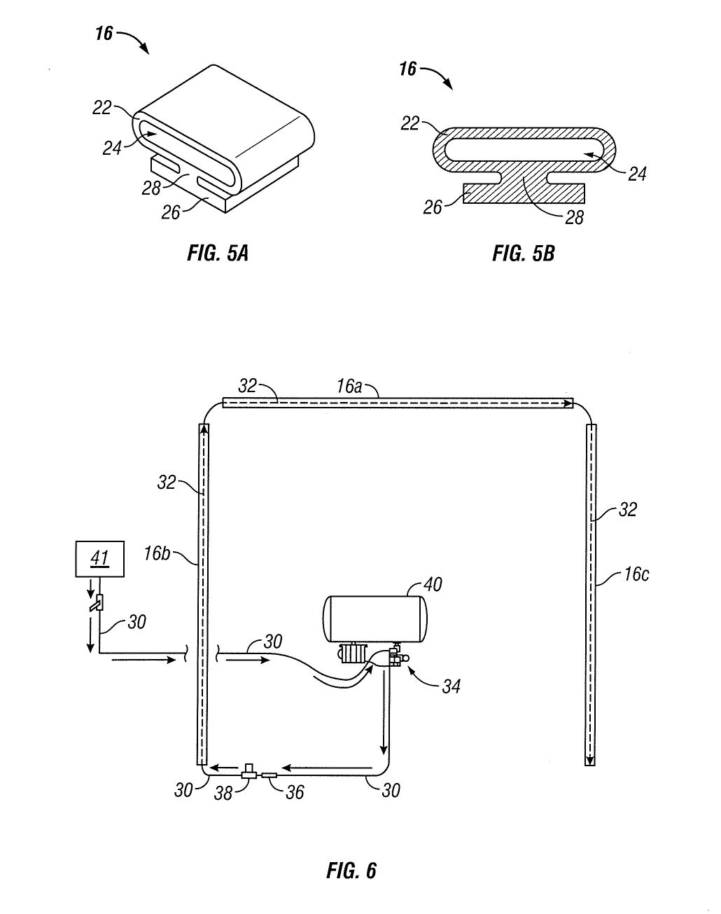

Exemplary embodiments of a pneumatic seal apparatus 16 are shown in more detail in FIGS. 5A and 5B. Pneumatic seal apparatus 16 includes an elastic membrane 22 defining a channel 24 therethrough. As discussed in more detail herein, the elastic membrane 22 expands when the channel 24 receives pressurized air. The elastic membrane 22 may be made of any lightweight, strong, elastic material including fluoroelastomer, polyether urethane, styrene butadiene, epichlorohydrin, EPDM, silicone, butyl, nitrile, neoprene, natural rubber, or any combination of such materials. In exemplary embodiments, the pneumatic seal includes a base member 26, which is sized to fit into seal track 20. A neck portion 28 may be located between elastic membrane 22 and base member 26 and may connect the elastic membrane 22 to the base member 26. It should be noted that a variety of different pneumatic seal arrangements could be used, so long as an elastic, expandable material defines a channel for injection of air.

In exemplary embodiments, the pneumatic seal apparatus 16 of door sealing system 10 receives air 32 from the trailer's air supply line 30. The trailer supply line 30 may be fluidly connected to the trailer parking brake release 34 such that air 32 from the supply line 30 joins the trailer supply line system at the brake release 34. The supply line 30 is coupled to activator/pressure protection valve 36 and regulator 38. Ultimately, the supply line 30 is fluidly connected to the pneumatic seal apparatus 16. An example of this embodiment is illustrated in FIG. 6.

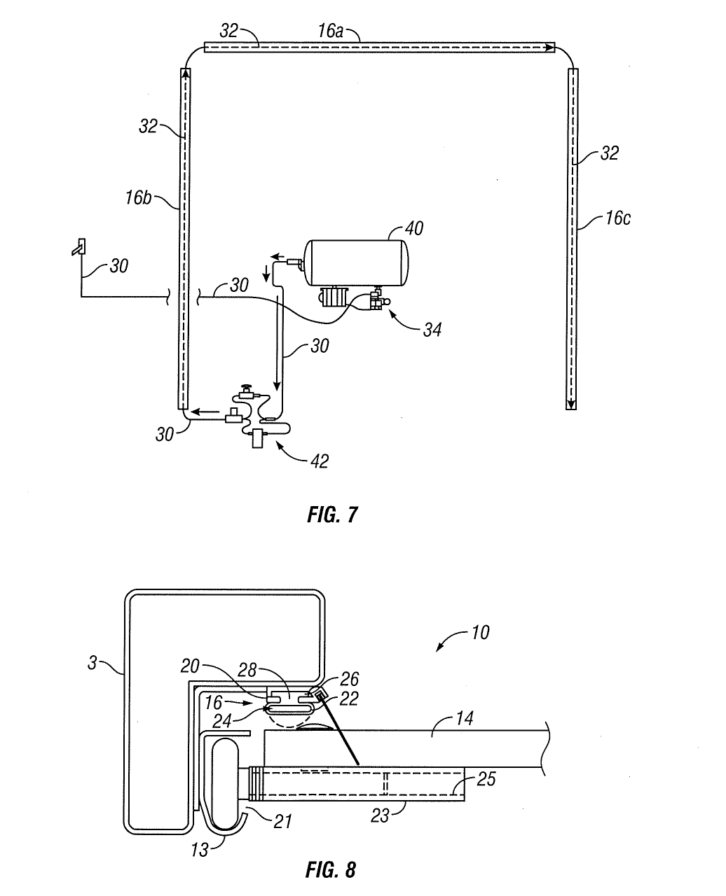

Another exemplary embodiment, shown in FIG. 7, supplies air 32 to the pneumatic seal apparatus from the trailer's air reservoir 40, which receives air from an external air supply 41. A supply line 30 is fluidly connected to the air reservoir 40 and extends to control valve 42 and then regulator 38, which serves to regulate the pressure of air 32. Regulator 38 may be configured to allow air flow at a pre-determined pressure or within a pre-determined pressure range and automatically cut off the flow of air 32 if the pressure is outside the pre-determined range. Ultimately, the supply line 30 is fluidly connected to the pneumatic seal apparatus 16. It should be noted that the control valve 42 could be manually operated or automatically controlled electrically, e.g., an electric solenoid valve, or via wireless communication. The trailer's refrigeration unit 44 could be fluidly connected to the supply line 30 to provide pressure to air 32. In operation, the user first closes the roll-up door assembly 12, which may be accomplished by moving the door assembly 12 downward in door track 13, the door track 13 optionally engaged by rollers 21, mounted to the door via roller mounts 23 mounting the roller axle posts 25 (see FIG. 8). The air 32 originates either from an air source 41 external to the trailer 1 or from the trailer's air reservoir 40. The air 32 travels through the trailer supply line 30 and may pass through the trailer parking brake release mechanism 34. From the brake release 34, the air 32 passes through pressure protection valve 36 and regulator 40 to the pneumatic seal apparatus 16. This could be an automatic process. Alternatively, in a manual process, the air 32 originating from the air reservoir 40 could bypass the brake release 34 and pass through control valve 42 and regulator to the pneumatic seal apparatus 16. In either case, the air 32 could be pressurized by the refrigeration unit 44.

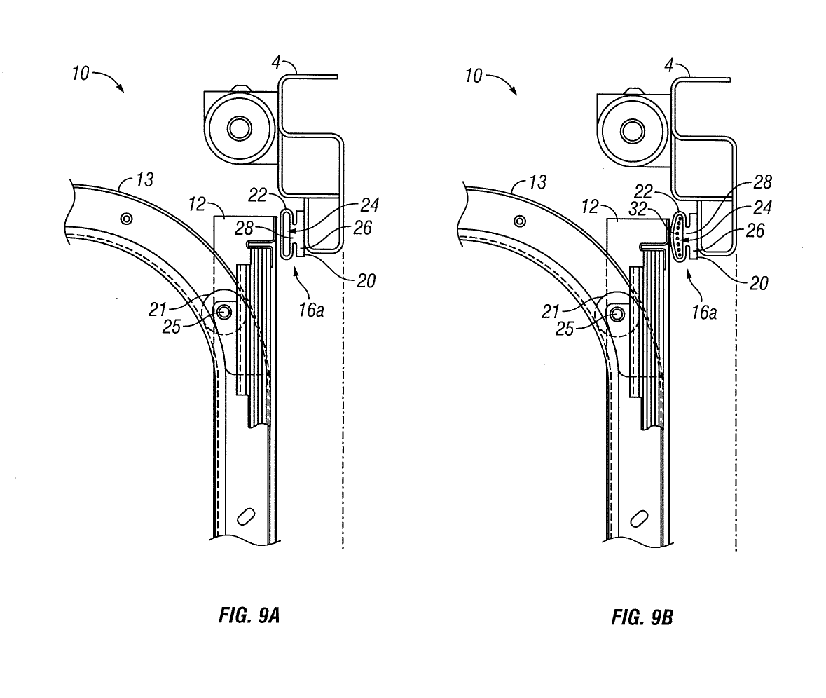

When the air 32 enters the pneumatic seal apparatus 16 it fills the channel 24. As best seen in FIGS. 8, 9A and 9B, this causes the elastic membrane 22 of the seal apparatus 16 to expand. The expanded membrane 22 applies an outward force against at least one panel 14 of the roll-up door assembly 12. This outward force or pressure provides a seal to the roll-up door assembly 12 and prevents movement of the panels 14 such that the panels 14 press against each other. As a result, the door assembly 12 is tightly shut.

To unseal the pneumatic seal apparatus 16 and open the door assembly 12, control valve 42 may be automatically shut to stop the flow of air 32 to the pneumatic seal apparatus. Alternatively, the user could manually shut pressure protection valve 36 to stop the flow of air 32. With the air flow shut off, as the air 32 exits door post seal 16c it is not replaced with additional air flow. This causes channel 24 to empty and the elastic membrane 22 to contract, removing outward pressure on the roll-up door assembly 12. The panels 14 can now move and the door assembly 12 can be opened.

Thus, it is seen that pneumatic sealing systems and methods are provided. It should be understood that any of the foregoing configurations and specialized components or may be interchangeably used with any of the apparatus or systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the disclosure.

What is claimed is:

1. A door sealing system comprising:
a roll-up door assembly including at least one door panel;
a pneumatic seal apparatus adjacent the at least one door panel, the pneumatic seal apparatus including:
an elastic membrane defining a channel therethrough; and
a base member fixedly attached to the elastic membrane via a neck portion;
the elastic membrane being expandable by injection of pressurized air such that an expanded membrane applies outward force against the door panel to seal the roll-up door assembly.

2. The system of claim 1 wherein the elastic membrane, the base member, and the neck portion are integrally formed.

3. The system of claim 1 further comprising a valve, the valve regulating flow of pressurized air into the channel.

4. The system of claim 1 wherein the pressurized air is supplied from a trailer supply line.

5. The system of claim 4 wherein the trailer supply line is fluidly connected to a brake release.

6. The system of claim 1 wherein the pneumatic seal apparatus comprises a header seal, a pneumatic gasket, and a door post seal.

7. The system of claim 1 wherein the at least one door panel comprises a plurality of door panels.

8. The system of claim 1 wherein the pressurized air is supplied from a trailer air reservoir via a regulator.

9. The system of claim 1 wherein the air is pressurized by a refrigeration unit.

10. A sealing system for a trailer door, comprising:
a trailer having an air supply line and a roll-up door assembly including at least one door panel;
a pneumatic seal apparatus adjacent the at least one door panel, the pneumatic seal apparatus including:
an elastic membrane defining a channel therethrough; and
a base member fixedly attached to the elastic membrane via a neck portion;
the elastic membrane being expandable by injection of air traveling to the channel via the air supply line such that an expanded membrane applies outward force against the door panel to seal the roll-up door assembly.

11. The system of claim 10 wherein the trailer supply line is fluidly connected to a brake release.

12. The system of claim 10 wherein the pressurized air is supplied from a trailer air reservoir via a regulator.

13. The system of claim 10 wherein the pneumatic seal apparatus comprises a header seal, a pneumatic gasket, and a door post seal.

14. The system of claim 10 wherein the at least one door panel comprises a plurality of door panels.

15. The system of claim 10 further comprising a refrigeration unit fluidly connected to the trailer supply line wherein the air is pressurized by the refrigeration unit.

16. A method of sealing a trailer door, comprising:
injecting pressurized air into a pneumatic seal apparatus having an elastic membrane defining a channel therethrough such that an expanded membrane applies outward force against a door panel to seal a roll-up door assembly.

17. The method of claim 16 further comprising pressurizing the air using a refrigeration unit.

18. The method of claim 16 further comprising supplying the air from a trailer air reservoir via a regulator.

19. The method of claim 16 further comprising supplying the air via a trailer supply line.

20. The method of claim 19 wherein the trailer supply line is fluidly connected to a brake release.
